(19) United States
(12) Patent Application Publication
(10) Pub. No.: US 2012/0256914 A1
(43) Pub. Date: Oct. 11, 2012

(54) CONSULTING DIGITAL MODELS FROM LIGHTWEIGHT TERMINALS

(75) Inventors: Pascal CHEVOCHOT, Bruz (FR); Jérôme PIROT, Saint Didier (FR)

(73) Assignee: SOGITEC INDUSTRIES, Surenes (FR)

(21) Appl. No.: 13/440,599

(22) Filed: Apr. 5, 2012

(30) Foreign Application Priority Data
Apr. 11, 2011 (FR) 1153137

(51) Int. Cl. G06T 17/00

(52) U.S. Cl. 345/419

(57) ABSTRACT

A consultation system enables a user of a lightweight client terminal (3) to interact with a three-dimensional digital model by displaying images produced in a server (2) from a detailed version of the model and displaying, during manipulation of the observation conditions, images calculated in the client terminal (3) based on coarsened data received from the server (2) and representing a simplified version of the model's geometry. The detailed images are accompanied by semantic mappings specifying, for the image pixels, an identifier of the part represented at the corresponding image location. The user designates a part in the model by indicating an image pixel and the user terminal identifies the part by referring to the semantic mapping. Parts selected by the user are highlighted by displaying over the main image either an image produced from the semantic mapping or a thumbnail calculated from the digital model.

### CROSS REFERENCE TO RELATED APPLICATION

The present application claims the benefit of the earlier filing date of patent application no. 1153137 filed in the French Patent Office on Apr. 11, 2011, the entire content of which application is incorporated herein by reference.

### BACKGROUND

1. Field of the Disclosure

The present disclosure relates to the field of viewing digital models and of interacting therewith.

The invention provides a digital model consultation system that makes it possible for lightweight terminals (thin terminals) to consult digital models that are voluminous.

2. Description of Related Art

There are several applications of a variety of types that enable a user to consult a digital model, i.e. a three-dimensional model that is accompanied by associated metadata. In this regard mention may be made, for example, of digital catalogs, computerized maintenance manuals, computer-assisted teaching systems, etc. At present, the use of three-dimensional models is becoming more widespread.

A user who desires to consult a digital model of this kind seeks not only to be able to view the product and/or the parts therein, but also requires a degree of interactivity with the graphical representation of the product and/or of the parts being viewed. More precisely, the user desires a consultation system that enables the user to:
define the scene, i.e. all of the parts the user desires to observe;
view the scene;
move relative to the viewed scene;
select or designate parts (in order to perform actions on them); and
highlight by some particular graphics rendering) a part selected/designated by the user, including parts that are hidden while viewing the parts according to their arrangements within the digital model.

A three-dimensional digital model that corresponds to a complex industrial product that is made up of assemblies and of subassemblies of parts, such as an airplane, is represented by a large quantity of data, in particular several million parts and several hundreds of millions of individual surfaces. Problems arise when it is desired to enable a user to consult such a voluminous digital model from a lightweight terminal (i.e. a terminal having limited resources) and/or remotely by means of a network connection, in particular via a wide area network (WAN).

If the voluminous data representing the three-dimensional model is delivered to the user terminal via a network, then downloading time becomes excessive. Furthermore, if the user terminal is not of very high performance in terms of calculation power and its quantity of available memory, it will not be capable of performing the calculation needed in order to display a desired view of parts and/or indeed to implement the interactivity expected by the user.

However, if the data representing the three-dimensional model is not delivered to the user terminal, then each time the user seeks to interact with a graphics representation of the model as displayed on the terminal, it becomes necessary to request the server to produce the appropriately modified data. The data transfer speed of the network will not be sufficient to enable the :35 necessary data to be downloaded quickly and the considerable response time will degrade interactivity.

One solution consists in providing the user with a physical medium, e.g. a compact disk read-only memory (CDROM) or a digital video disk (DVD) storing the three-dimensional geometrical data that defines the digital model (and also the associated metadata) Nevertheless, that solution possesses the drawback of disseminating technical data corresponding to a major portion of the manufacturer's intellectual property and that might make it possible to produce counterfeit versions of the parts making up the modeled product. Furthermore, if the user only has a lightweight terminal available (lightweight in terms of processor performance and/or memory size), then the terminal will still riot be capable of performing the necessary data processing with an acceptable response time.

The invention has been devised in the light of the above-mentioned problems.

### SUMMARY

The present invention provides a system for consulting a digital model, the system comprising a server and at least one user terminal connected together by a communications link, the server including means for accessing data defining at least a three-dimensional digital model. The user terminal includes a display unit and a user interface enabling the user to manipulate the observation conditions to be employed when displaying the digital model, and to define a scene corresponding to a subset of the parts making up the digital model. In the system, the server is adapted to transmit to the user terminal, via the communications link: detailed image data corresponding to the scene defined by the user terminal, as calculated in compliance with the observation conditions defined by the user terminal, the detailed image data being calculated on the basis of data defining the parts of the digital model according to a detailed geometry, and coarsened (light) data defining the same scene according to a simplified geometry. In the system the user terminal further includes: receiver means adapted to receive the detailed image data and the coarsened data, the display unit being adapted to display a detailed image on the basis of the detailed image data received from the server; and calculation means adapted to calculate image data representing the same scene during a change of observation conditions, on the basis of the coarsened data

It should be understood that the expression “coarsened data” does not imply the performance of some data processing operation that could be designated “coarsening”. The expression “coarsened data” simply indicates that this data defines the three-dimensional model according to a geometry that is simplified or of lower precision in comparison to the detailed geometry that is used for producing the detailed images.

The system according to the invention makes it possible to obtain satisfactory reactivity while interactively consulting a digital model, even if the model is voluminous, and while using a terminal that possesses computer resources that are relatively modest compared with those that have been required by prior art consultation systems. Nevertheless, the quality of the images that are displayed, other than during periods in which observation conditions are in the process of being manipulated, is better than that which can be obtained by using the user terminal's own resources.

The user terminal may be an ordinary computer running specific software, in particular a computer that has limited resources or indeed some other lightweight terminal (smartphone, etc.). Even lightweight terminals of this kind can provide the user with satisfactory reactivity because the updating of the image as a result of a change in the point from which the scene is observed (or a change in some other manipulation of the observation conditions) does not require the terminal to have a large amount of calculation power nor does it require a new request to be sent to the server.

In this client, server architecture, the detailed geometrical data defining the parts of the digital model is conserved at the server. This feature provides two major advantages:
protecting intellectual property rights of the creator of the model; and
providing a high level of performance because of the reduction in the volume of the data that is transferred to the client.

The client-server architecture characterizes a system made up of a server function, which may be spread over one or more physical devices, and a client function that may he instantiated on one or more client terminals, independently of the way in which communication is implemented between the server and the client,

Advantageously, the server has means for generating coarsened data and for transmitting it to the client, where the coarsened data corresponds to a simplified version of the digital model. This generation of coarsened data may be performed:
in a preparatory step prior to making each digital model available; or
“on the fly”, i.e., at the request of the user on the basis of the detailed data and without any coarsened data being prepared beforehand or stored,

In certain embodiments, the system of the invention includes semantic mapping calculation means adapted to calculate a semantic mapping that indicates, for each location in the detailed image, an identifier of the corresponding part in the digital model, and the calculation means of the user terminal is adapted, when the user indicates a location in a detailed image displayed by the display unit, to identify the part designated by the user by consulting the semantic mapping in order to determine which part in the model corresponds to the location designated by the user. Advantageously, in a client-server architecture, the semantic mapping is calculated at the server and transmitted to the client, in particular in parallel with transmitting the coarsened data.

The semantic mapping enables the user to designate (e.g. by using a mouse) a part having at least a portion that is visible in the displayed image, and the system can identify the part in question by referring to the semantic mapping, which is much less onerous in terms of calculation than the methods used ordinarily, and it does not require the detailed geometry to be available at the client terminal.

Furthermore, it is possible to design the calculation means of the user terminal in such a manner as to be capable of controlling the rendering of pixels of the image displayed by the display unit so that the pixels of the image that correspond to the part selected by the user, as identified from the semantic mapping, are rendered in a manner that highlights the part in question. The semantic mapping serves to identify quickly the pixels in question for which the rendering (color, brightness, etc.) needs to be controlled, thus enabling the part of interest, to the user to be highlighted, and without any need to send an additional request to the server.

Advantageously, the system of the invention includes means for calculating thumbnails, which means is adapted to calculate image data defining thumbnails (miniature images) corresponding to parts that are visible in the detailed image displayed at the user terminal, and the calculation means of the user terminal is adapted; when the user selects a part displayed by the display unit, to verify whether the user terminal has a thumbnail for the part in question and, in an appropriate case, to cause the received thumbnail to be displayed over the displayed image. Advantageously, in a client-server architecture, the thumbnails of the parts having at least a portion that is visible in the detailed image are calculated at the server and they are transmitted to the client, in particular after the semantic mapping has been transmitted.

When the user terminal has a thumbnail corresponding to a part that the user designates from the image displayed by the display unit, the terminal may highlight the part in question by displaying, in superposition on the main image, the image of the thumbnail, possibly shown in ghost form (i.e., for example, by modifying the brightness and by adding a halo around the thumbnail). This way of highlighting a part selected by the user makes it possible to view a part that is hidden in the image as displayed from the point of view chosen by the user.

With assemblies of parts, it may be useful to employ thumbnails that are rendered in a manner that depends on the hierarchical level of each part in the assembly. For example: a bolt may form part of a lock, and the lock may form part of a door. When highlighting the assembly corresponding to the door (or indeed to the bolt), a particular rendering of the corresponding thumbnails may indicate visually that the lock corresponds to a subassembly of the door and that the bolt is a component of a subassembly of the lock. Advantageously, the transparency of the displayed thumbnail depends, for example, on its hierarchical level, thus making it possible for the user to assess very easily how the parts are arranged.

The present invention also provides a user terminal for consulting a three-dimensional digital model, which terminal is to form part of the above-mentioned system (in practice, the system will have several such terminals). The user terminal includes the display unit, the user interface, the receiver means adapted to receive the image data defining a detailed image and also the coarsened data, and the calculation means adapted to act during a change of observation conditions to calculate image data representing the scene on the basis of the coarsened data corresponding to a simplified version of the digital model.

Advantageously, the user terminal has calculation means adapted, when the user indicates a location in a detailed image displayed by the display unit, to identify the part selected by the user by consulting the above-mentioned semantic mapping.

Advantageously, the user terminal has calculation means that are adapted to control the rendering of the pixels of the image displayed by the display unit so that the pixels of the image that correspond to the part selected by the user, as identified from the semantic mapping, are rendered using displaying that highlights the part in question.

Advantageously, the user terminal has calculation means that are adapted, when the user designates a part in the image displayed by the display unit, to verify whether the user terminal has a thumbnail of the part in question and to cause the thumbnail to be displayed in superposition on the displayed image.

Advantageously, the user terminal has calculation means that are adapted, when the user designates an assembly in the image displayed by the display unit, to verify whether the user terminal has thumbnails for the parts of the assembly in question and to cause the thumbnails of the parts of said assembly to be displayed with hierarchical rendering in which the transparency of a displayed thumbnail depends on the level of the corresponding part in the assembly hierarchy.

The present invention provides a server for forming part of the above-mentioned system, in a client-server architecture. The server comprises means for accessing data that defines the three-dimensional digital model according to a detailed geometry, and a client interface adapted to receive requests from the client and to provide data in response; the server comprising means for calculating image data defining a detailed image of a scene defined by a client and viewed under the observation conditions defined by the client, said scene corresponding to a client-selected subset of the parts of the digital model, the detailed image being calculated from said data defining the digital model according to the detailed geometry, and the client interface being adapted to send to the client the detailed image data, and coarsened data corresponding to a simplified version of said scene defined by the client.

Advantageously, the server includes powerful image calculation means, such as one or more graphics processor units (GPUs) for calculating the detailed images that are transmitted to the clients, said means being shared amongst all of the clients.

Advantageously, the server includes means for calculating a semantic mapping, which means are adapted to calculate the above-mentioned semantic mapping, and the client interface is adapted to transmit said semantic mapping to the client.

Advantageously, the server includes means for calculating the above-mentioned thumbnails.

The present invention provides a computer program product for implementing consultation of a three-dimensional digital model via a communications link, the product comprising instructions for performing, at execution, the step of inputting an instruction from a user indicating the observation conditions to be employed when displaying the three-dimensional digital model and defining a scene corresponding to a subset of the set of parts of the digital model. The computer program product further includes instructions for performing the following steps on being executed:
receiving from a server and via the communications link detailed image data defining a detailed image of the user-defined scene as displayed under observation conditions indicated by the user (the image data being calculated from data defining the three-dimensional digital model according to a detailed geometry), and coarsened data defining said scene according to a relatively simpler geometry; and
calculating image data representing said scene, during a change of observation conditions, on the basis of the coarsened data received from the server, and displaying the image data produced during the calculation step.

The present invention also provides a server computer program product for implementing consultation of a three-dimensional digital model, the product comprising instructions for performing the following steps on being executed: receiving a request from a client; and supplying data to the client in order to respond to the request; the product further includes instructions for performing the following steps, on being executed: accessing data defining the three-dimensional digital model according to a detailed geometry, using said data defining the digital model according to the detailed geometry to calculate image data defining a detailed image of a client-defined scene viewed under observation conditions defined by said same client, said scene corresponding to a client-selected subset of the parts of the digital model, and transmitting to the client: the detailed image data, and coarsened data corresponding to a simplified geometry of said scene.

### BRIEF DESCRIPTION OF THE DRAWINGS

The above-mentioned features and advantages, and others, will be better understood on reading the following description of certain embodiments of the invention, given as illustrative examples that are not limiting in any way, with reference to the accompanying drawings, in which:

FIG. 1 shows the makeup of a system for consulting a digital model in a preferred embodiment of the invention, possessing a client-server architecture;

FIG. 2 shows an example of a graphical user interface in a client in the FIG. 1 system;

FIG. 3 shows examples of images displayed by a client in the FIG. 1 system, in which:

FIG. 3A shows a detailed image as computed by the server; and

FIG. 3B shows an image as calculated at the client end based on coarsened data;

FIG. 4 shows a silhouette employed for ascertaining the user's position relative to the digital model;

FIG. 5 shows an example of a semantic mapping used by the preferred embodiments of the invention, and corresponding to the image shown in FIG. 3A;

FIG. 6 illustrates a first method of highlighting a selected part;

FIG. 7 illustrates a second method of highlighting a selected part, this method making use of thumbnail images;

FIG. 8 illustrates a method of highlighting the parts of an assembly by using thumbnail images that are rendered in a hierarchical manner;

FIG. 9 shows various steps in transmitting data from the FIG. 1 server to one of the clients;

FIG. 10 illustrates a method of loading and displaying a detailed image, that may be employed in the preferred embodiments of the invention;

FIG. 11 shows a method of loading simplified geometry data, that may be employed in preferred embodiments of the invention;

FIG. 12 shows the functions that are implemented at the client end and at the server end in a preferred embodiment of the invention when moving the observation point of the digital model;

FIG. 13 illustrates a method of designating and highlighting parts, which method may be employed in a preferred embodiment of the invention; and

FIG. 14 shows the makeup of a system for consulting a digital model, implemented on an autonomous (independent) terminal.

### DESCRIPTION OF CERTAIN EMBODIMENTS

Embodiments of the invention are described below with reference to three-dimensional consultation of parts, assemblies, or an entire industrial product, and of complex physical systems, using a digital model that may be extremely voluminous. Preferred embodiments of the invention have a client-server architecture. The system may also be implemented on an autonomous terminal (i.e. without the intervention of a physical server processing the data of the digital model).

In order to simplify the explanation of how the invention operates, the description below relates to embodiments in which there is only one digital model. It should be noted that the invention is not limited in this respect: a single system of the invention may enable a plurality of digital models to be consulted, and each user may create a scene based on the model of his choice.

### Client-Server Architecture

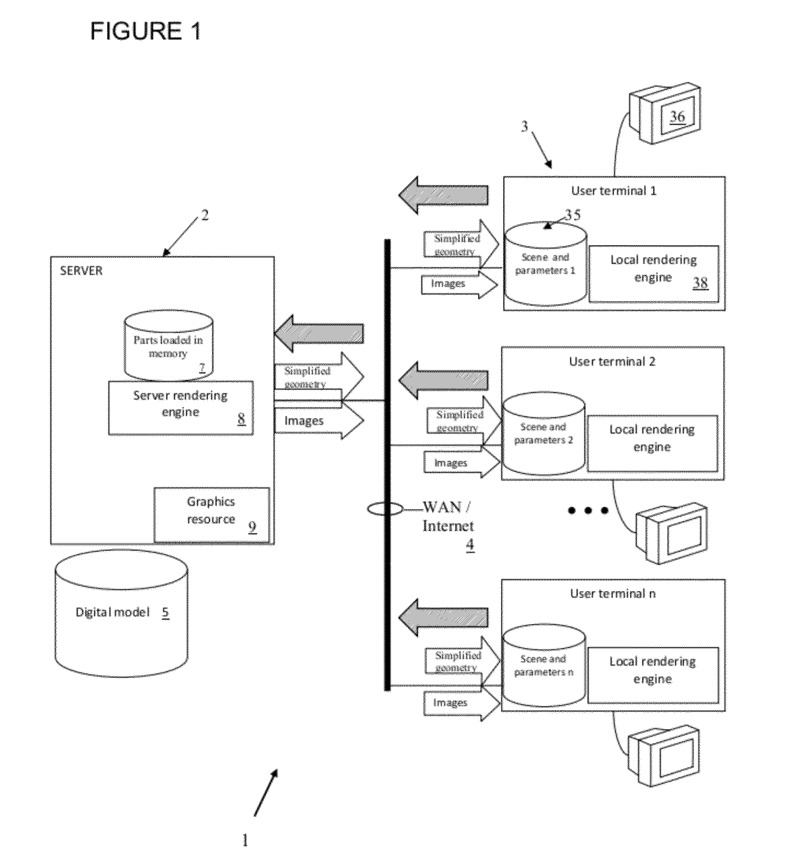

FIG. 1 shows an example of a system 1 for consulting a digital model in a preferred embodiment of the invention, the system having a client-server architecture in which only the server has access to the complete (detailed) data concerning the digital model. It should be noted that the expression “digital model” is intended to designate a digital version of an object comprising all of the three-dimensional (3D) models of the constituent parts both in a fine” geometry version (to be used by the server) and in a “simplified” geometry version to be used by the client)—together with a tree structure for positioning the 3D part models relative to one another in three dimensions (e.g., a scene graph).

The example of FIG. 1 relates to a system 1 having a server 2 that serves multiple clients 3 and a digital model that represents the parts making up an airplane. It should be observed that this embodiment of the invention is not limited as to the number of clients 3 served by the server 2, nor as to the item represented by the digital model. It is also possible to share the functions of the server 2 amongst a plurality of machines, in particular a battery of servers having stateless servers, so as to avoid problems in the event of a server failing. It should be understood that in the present specification, the term “server” may designate such a set made up of multiple servers.

In general, it is appropriate for the data defining the digital model to be loaded into large capacity storage means 5, since this data is usually very bulky (voluminous). The server 2 may access the digital model data stored in the storage means 5, with the storage means being either local to the server 2 or else connected to the server, e.g. via local area network (LAN), etc. When the server is used in the manner described below, the server 2 loads data defining certain parts into its memory 7, in particular, data according to the “detailed” geometry version defining the parts that have been identified by requests coming from clients 3. The loaded data comprises not only the detailed 3D models of the selected parts, but also appropriate information relating to the positioning of these parts relative to one another in three dimensions. Although not shown in FIG. 1, the server continuously maintains—for each client 3—details of parameters concerning each user and the data needed for generating images defining the scene requested by the client and also defining the observation conditions.

In general, the server 2 has good calculation and memory resources, in particular resources of a capacity related to the number of expected simultaneous clients. The server 2 preferably has sufficient memory to be capable of loading all of the displayable parts of the model. Furthermore, it is advantageous for the server 2 to include a graphics resource that enables it to calculate an image in a few milliseconds. Each client's usage of the server 2 is low because server calculations are required only when movements or other manipulations of observation conditions come to an end (see below). It is thus possible for the server to be shared between a large number of users.

The server 2 has a rendering engine 8 and a graphics resource 9 enabling high-resolution images to be calculated based on the digital model's detailed geometrical data stored in the storage means 5. The server 2 is also provided with means (not shown) for transferring coarsened data (or “light data”) that defines the parts of the digital model in the “simplified” geometry version, this coarsened data comprising degraded 3D models of the selected parts together with appropriate information relating to the spatial positioning of the parts in three dimensions. The positioning information contained in the coarsened data is not of degraded precision.

The coarsened data defines the geometry of the scene to be viewed in a manner that is sufficiently degraded to enable it to be calculated and displayed based on 3D models by a machine that has limited resources, and for ensuring intellectual property protection of industrial data, but the geometry remains sufficiently well-defined to enable the user to navigate in the model.

Various ways of producing the coarsened data can be devised by the person skilled in the art, such as, for example, using a smaller number of individual surfaces for defining each part and/or changing the sizes and/or shapes of the surfaces, changing the modeling, etc. Optionally, the coarsened data may include a symbolic representation of one or more of the parts in the scene for viewing, such as, for example, crosses to indicate fasteners, and lines to indicate tubes, boxes with texturing to represent the equipment present at the indicated position, etc.

The nature and/or the extent of the simplification may be controlled so as to take into account the capacities of the client, in particular when the client has previously informed the server of its capacities. In particular when the server calculates the coarsened data “on the fly”, this calculation may be adapted to the capacities of the client. Furthermore, the server may have a plurality of simplified representations of a particular scene, each presenting a different type and/or degree of simplification, and it may make a selection amongst these representations, dependent on the capacities of the client, when transmitting coarsened data to the client.

In the embodiment shown in FIG. 1, the server 2 serves an arbitrary number n of clients 3. Each client 3 of the server 2 corresponds to a user terminal. The performance of each user terminal 3, in particular in terms of processing power and memory power, is not particularly limited. Nevertheless, the invention seeks to make it possible to use conventional office machines as user terminals 3, i.e. lightweight terminals whose graphics performance generally is not suited to fast 3D viewing and having random access memory (RAM) that does not enable a significant portion of a digital model to be loaded when it is in the form of non-degraded 3D data.

In the embodiment shown in FIG. 1, each client 3 has storage means 35 for maintaining the present details (and possibly also a history) of the scene being viewed and of the parameters relating thereto (observation point, observation conditions, selected part(s), etc.). A local rendering engine 38 enables the client 3 to calculate images that will be displayed on a screen 36, or on other display means, while the observation point of the scene is being moved (or indeed during some other manipulation of the observation conditions).

### Connection Between the Server and the Client

The invention is not particularly limited concerning the nature of the connection between the server 2 and the client 3: for example it is possible to use a local area network (LAN), a WAN, the Internet, an Intranet, etc. In the example shown in FIG. 1, the clients 3 are connected to the server 2 via a WAN 4, and the invention possesses the advantage of enabling a complex three-dimensional digital model to be consulted remotely even while using conventional Internet connections that provide a slow or medium transfer speed. The system of the invention gives the user of a lightweight terminal a level of interactivity comparable with that which would be offered by a workstation in a remote consultation context, even when using a network with a transfer speed as slow as 50 kilobytes per second (KBps) and a latency of several hundreds of milliseconds.

As is indicated in FIG. 1 using gray arrows, the client 3 sends requests to the server 2 and the server responds by sending different data to the various clients, in particular both detailed images and coarse three-dimensional part-model data. The data is generally transferred over the network using standard protocols, compression means, and encryption means. The architecture also makes it possible to implement any transfer protocol and any encryption and compression means adapted to specific requirements. Furthermore, in order to avoid any unauthorized use of the data, it is possible to implement protective measures, such as measures for user authentication and for encryption.

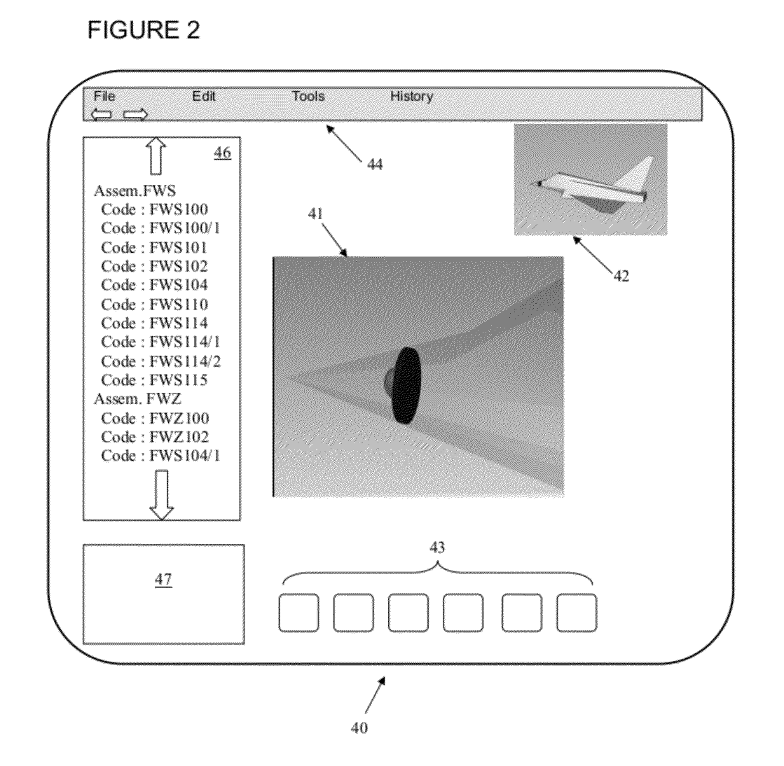

The way functions are divided between the server 2 and the client 3 in this embodiment of the invention can he better understood on reading the following description of an example illustrated using FIGS. 2 to 13.

### Graphic Interface

FIG. 2 is a diagram showing the content of a graphical user interface 40 that may be used at the client end for managing the consultation of the three dimensional digital model by the user and for implementing interactive functions. The embodiment shown in FIG. 2 relates to referring to a digital model in the context of consulting an on-line catalog of parts making up an airplane. In this case, the digital model includes not only a three-dimensional model of the airplane and its components, but also associated metadata such as the references of the parts, the parameters of the parts (materials, physical properties, versions, etc,), links, e.g. to points of sale, to a maintenance manual, or to some other document, etc.

It should be noted that the appearance and the content of the graphical user interface 40 may vary substantially depending on the intended application and on choices made by the designer; the interface shown in FIG. 2 is a diagrammatic representation of a simple example.

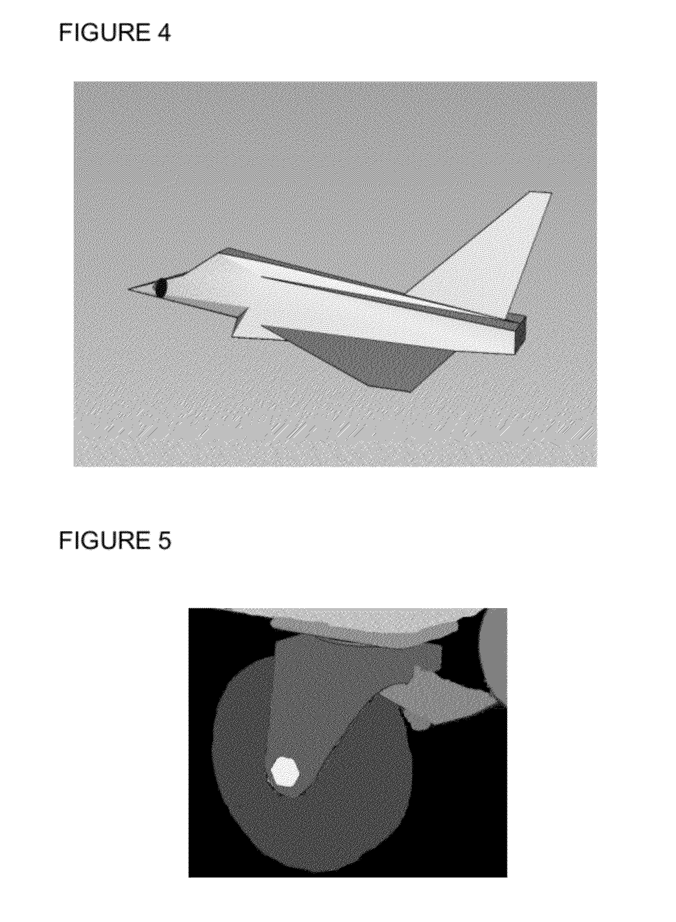

In the example shown in FIG. 2, an image of the parts that interest the client is displayed in a window 41 that forms part of the interface 40. The invention is not particularly limited concerning the method used by the user to identify the content of the scene the user seeks to view: the parts for viewing may be specified explicitly, e.g. by selecting parts from their references in a list 46 that is displayed on the screen and that indicates the constituent assemblies and parts of the digital model, however it is also possible for the user merely to identify a region of the digital model that is to be viewed, e.g. by using a mouse to move a cursor within the window 41 or by making use of an optional guide image 42 that serves to identify a position relative to the three-dimensional model of the entire product. (The guide image 42 is shown at a larger scale in FIG. 4: this guide image 42 is advantageously displayed as soon as the application is launched.)

The set of parts that a client seeks to view at a given moment is referred to in this specification by the term “the scene”, independently of whether an image of this scene is being displayed, and of whether all of the data relating to the scene has reached the client. In the text below, it should be understood that references to the client providing an indication of the scene to be viewed, cover any way of specifying the part or the region of the model that the client seeks to view.

It should be recalled that the image displayed in the window 41 of FIG. 2 may correspond to an empty scene, i.e. a background, possibly with some indicated features, but without an image of any part of the three-dimensional digital model. This occurs, in particular, when the application is launched and before the user has selected any parts to be viewed.

The graphical user interface 40 also includes a control section 43 and a navigation section 44 that enable the user to perform various operations in relation to the on-line catalog and in relation to consultation of the digital model. The graphical user interface 40 may also include a region 47 in which there is displayed metadata, or indeed additional information, associated with a part selected by the user.

Depending on the intended application, the image displayed in the window 41 may include the parts identified by the user, possibly together with a portion of their environment, in particular for the purpose of making it possible to assess how the parts are positioned relative to other elements of the product. Naturally, it is possible to move aside any elements of the digital model that would prevent viewing of the parts that are to be displayed. The calculation means of the server and of the clients are programmed in compliance with the requirements of the applications to produce the scenes that are desired.

The graphical user interface 40 makes it possible for the user not only to identify the part or parts for viewing in the window 41; but also to specify observation conditions, in particular concerning the point from which the scene is to be viewed, the size of the image, the field of view, etc., and to do so in an interactive manner.

### Principle of Operation

The principle of operation of the system of the invention is described below with reference mainly to FIG. 1.

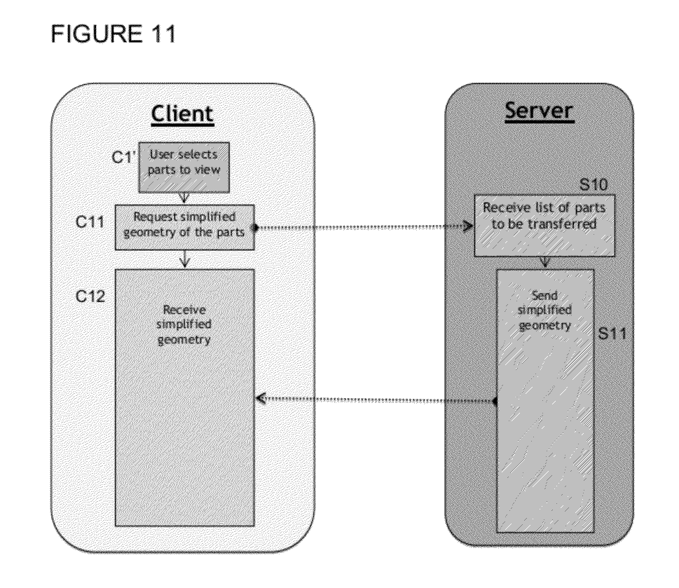

So far as the user is concerned, the function is that of a high-performance 3D consultation system with high image quality. At any instant, the user may define the scene interactively on the client terminal 3 and may access the metadata associated with the components of the model by making a selection graphically. A request identifying the scene that the user seeks to view, and the observation conditions, is sent to the server 2. The server then proceeds in several steps (that may take place in parallel or successively)
the server 2 sends the client 3 a series of 3D models having simplified geometrical precision (together with information relating to the positions of the models), these models corresponding to the parts that the client seeks to view (FIG. 11 is a diagram of exchanges that take place between the client 3 and the server 2 during this process);
the server 2 loads the same 30 models into its local memory (i.e. it loads the models of the same components of the model), together with appropriate positioning information, but at the best possible precision;
the server 2 calculates the 2D image of the 3D scene that has been requested, by making use of the precise geometrical data and the specified observation conditions, in order to produce a detailed image; and
the server 2 sends the detailed image to the requesting client 3: the data constituting the image possibly being subjected to appropriate compression and/or security (encryption, etc.) procedures.
   At the client end, the detailed image received from the server 2 is displayed in the window 41 of the graphical user interface.

When the user moves the scene observation point, by taking advantage of the interactive functions of the consultation system, it is necessary to update the image that is displayed in the window 41. The same applies when the user seeks to vary other observation conditions (field of view, image size, etc.). If it were necessary to make use of the server 2 for progressively updating the image during a movement (or indeed when changing any other observation condition of the displayed scene), then the latency of the network would give rise to waiting times that are very long and that would degrade the interactivity of the system. According to the present invention, the image is updated while changing observation conditions (moving the observation point, or some other change) at the client, end by using the coarsened data received from the server 2. The client's local rendering engine 36 is capable of performing the necessary processing of the simplified 3D models and the positioning information.

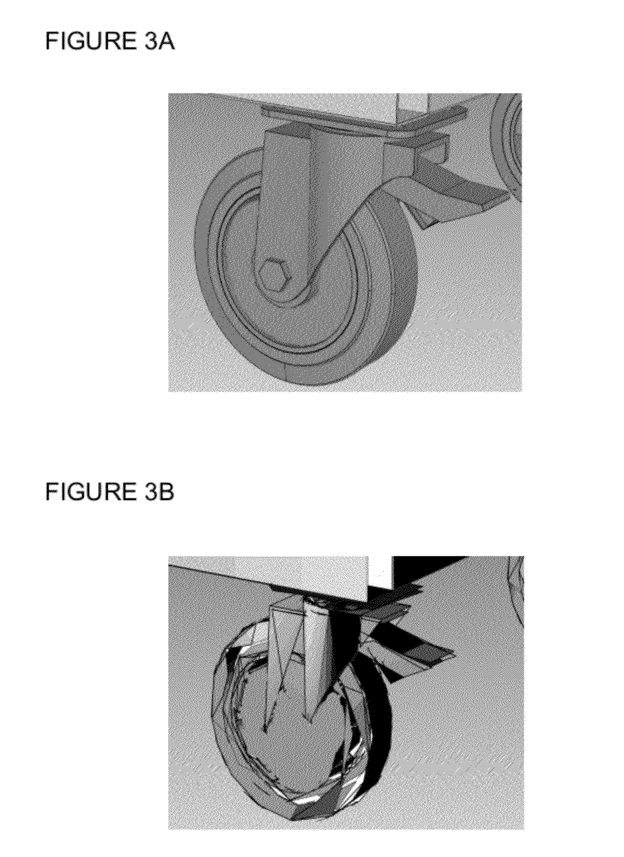

FIGS. 3A and 3B show images of an airplane wheel: FIG. 3A corresponds to a detailed image produced by the server 2 from the high precision data of the digital model, while the image of FIG. 3B corresponds to an image of the same scene, after a small displacement, as generated by the client 3 using the coarsened data.

When the user requests a modification in the observation conditions, e.g., a change of viewpoint, the image calculated by the client 3 based on the coarsened data (e.g. the image of FIG. 3B) replaces the previous image that came from the server 2. Once the user has finished moving or manipulating observation conditions, the client 3 requests a new image from the server 2 as before and replaces the locally-calculated image with the image newly received from the server 2.

### Partial Displays

The coarse 3D-model/positioning data corresponding to the scene displayed in the window 41 has not necessarily all arrived at the time the user begins a movement. The client's local rendering engine 38 is preferably arranged to update the image using all of the coarsened data that has been received up until the moment the updated image is generated, even if this is still incomplete.

### Guide Image

The guide image 42 enables the user to determine positioning while performing a movement at a time when the coarsened data has not yet all arrived. In general, the guide image 42 constitutes a special model associated with the digital model, and in this example it represents the silhouette of the airplane in question. The data defining the guide image 42 is delivered by the server 2 to the client 3 as soon as the application is launched or else it forms a part of the software that is associated with the application and is already loaded in the client terminal. The client's local rendering engine 38 is preferably adapted to change the orientation of the guide image 42 as a function of the observation conditions of the main scene. The calculation resources required for processing the guide image 42 are small because of the small volume of the data in question,

### Display and Selection

The sharing of image calculation functions between the server 2 (which performs calculation on the basis of the precise data of the digital model when the observation point is stationary) and the client 3 (which performs calculation on the basis of the degraded data during a movement) enables the user to view stationary images that are of high quality and to obtain a degraded display only during a displacement in the 3D scene and while manipulating observation conditions, without requiring a long waiting time and making use of the limited resources at the client end.

In the three-dimensional model consultation system of the invention it is optionally possible to provide a special solution for designating elements forming part of the model that are to be the object of user interactions. For this purpose, the client 3 may receive a “semantic mapping” enabling parts to be designated by using a mouse, or any other selector means (see below).

In the three-dimensional digital model consultation system of the invention it is optionally possible to provide a particular solution in terms of highlighting the component elements of the model that are the object of operator interactions. For this purpose, the client 3 may make use of the above-mentioned semantic mapping or may receive and make use of thumbnails (see below).

The two optional solutions mentioned above enable actions to take place substantially immediately when the user implements an interactive function, without extended delays to allow the client to load the degraded digital model. These solutions are described below and give the system very good fluidity, even on a network with a low transfer speed, e.g. a 50 KBps network.

A digital model consultation system gives the user the possibility of selecting a desired part from a graphical representation of the model, or from a portion thereof, e.g. for the purpose of performing a function on the part (recovering associated information, searching for a part reference, etc.). The user indicates the part that interests him by using a mouse or other means to point to an image displayed on the screen. In an advantageous embodiment of the invention, selection is performed at the client 3 by making use of a “semantic mapping” that is calculated by the server 2. The semantic mapping (which normally is not displayed by the graphical user interface 40) corresponds to the detailed image sent by the server and, for each position in the image, it includes an identifier of the part that is present at that position. The semantic mapping may be represented in any suitable form, e.g. in the form of a pixel-part correspondence table.

An example of a semantic mapping corresponding to the detailed image shown in FIG. 3A is itself shown diagrammatically in FIG. 5. In FIG. 5, each of the regions having a different gray level corresponds to a region of the image that is associated with a respective specific part that may be selected. Normally, the semantic mapping makes use of identifiers (e.g. codes) associated with the parts, and not of gray levels, for the purpose of identifying the parts that are associated with the various pixels of the image. The same part identifiers are used by the client 3 and the server 2.

The semantic mapping has the same characteristics in terms of image size, resolution, field of view, etc., as the detailed image calculated by the server, and as a result the calculated image and the semantic mapping coincide perfectly. Thus, when the user selects a part in the image displayed in the window 41, the position of the cursor in the image is used to address the semantic mapping, and thus to recover the identifier of the part being pointed to in the image.

Furthermore, the semantic mapping may include a table that serves, for each part identifier, to give information about other attributes, e.g. the material of the part in question, a link to a document, etc.

By way of example, the semantic mapping is calculated by the graphics processor unit (CPU) of the server 2 using the same method as is used for generating the detailed image, by replacing the color information that forms a part of the pixel data of the detailed image with information identifying the part in question.

FIG. 10 shows an example of the exchanges that may take place between a client 3 and the server 2 in order to load a detailed image and its semantic mapping relating to a list of parts selected by the user.

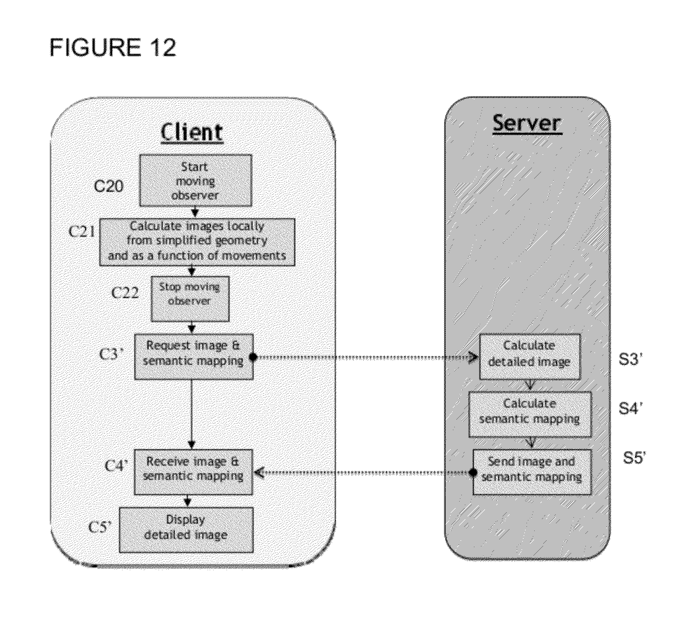

FIG. 12 shows similar exchanges that may take place between the client 3 and the server 2 when the user has stopped moving the observation point of the image or has stopped performing some other manipulation of the observation conditions.

Advantageously, the server transmits the semantic mapping to the client immediately after transmitting the associated detailed image. Usually, the semantic mapping reaches the client long before the client has finished receiving the simplified geometrical data. The semantic mapping enables the user to specify parts even when the simplified geometrical data has not yet all arrived. The use of the semantic mapping makes it possible to limit the number of requests that are sent to the server 2.

Contrary to conventional selection methods, selection by means of the semantic mapping may be performed without 3D calculation: there is no need to download the geometry from the server and thus the latency (time between the user performing an action and an action being taken on the image) is very short.

This selection by means of a semantic mapping is extremely fast, thereby enabling selection to take place continuously while the mouse, or any other selection means, is being moved over the image.

### Highlight

The semantic mapping may also provide the user with functions for highlighting a part in the image displayed in the window 41 of the graphical user interface 40 in a manner that is very fast and without requiring the server to send a new image. This highlighting function consists in modifying the rendering of certain pixels of the image that correspond to a given part, in order to make the part show up more clearly in the displayed image. The image pixels for which the rendering is modified are those that, according to the semantic mapping, have the part identifier of the part selected by the user. By way of example, the change in rendering may comprise a modification to the brightness of this portion of the image so as to change the shade of the part, brightening the outline of the part (using an outline detection method that is performed by the client terminal 3), and/or any other modification in rendering that enables the desired part to stand out in the image. All of the processing needed for performing the “simple highlight” function is implemented in the client terminal and none of it uses any additional dialog with the server.

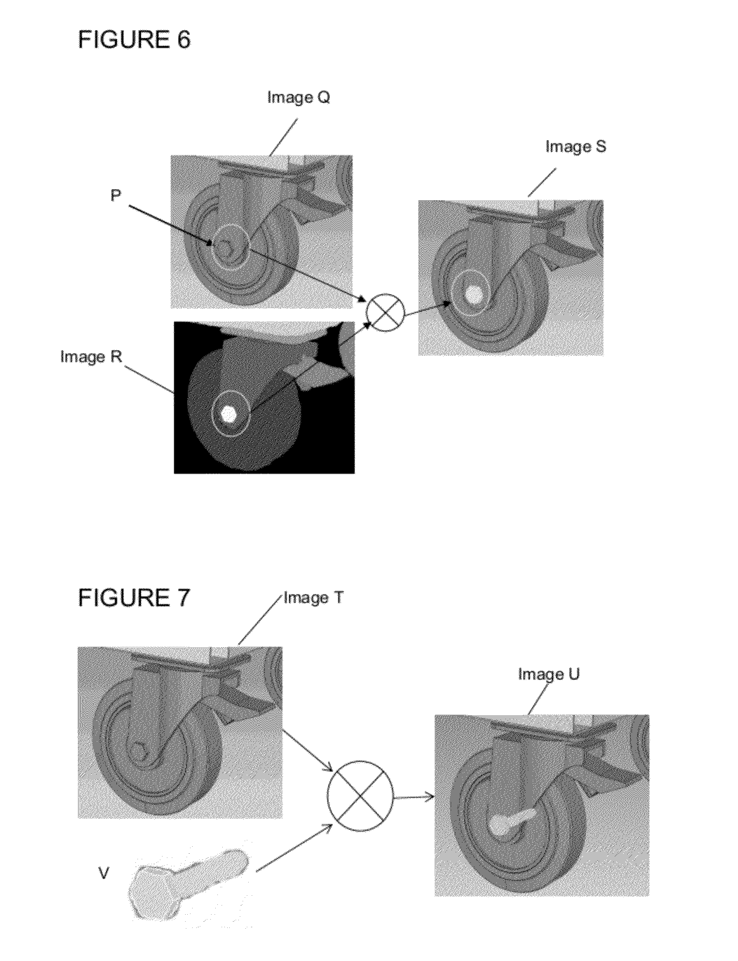

FIG. 6 shows images that illustrate the function referred to herein as “simple highlight” as performed by using the semantic mapping. The image Q of FIG. 6 corresponds to a detailed image calculated by the server; in this figure an oval surrounds the part P selected by the user. The image R of FIG. 6 shows the content of the semantic mapping in diagrammatic manner: the pixels that share the part identifier corresponding to the part P are shown white. The image S in FIG. 6 highlights the part P in the detailed image: it can be seen that the brightness of the way the part P is shown in the image S is increased compared with the brightness with which the same part is shown in the image Q.

In certain embodiments of the invention, another way of highlighting parts selected by the user is provided and this is based on thumbnails or miniatures representing the parts making up the model. The “thumbnail highlight” function makes use of thumbnails (miniatures) that are images that contain only the part in question, but the whole of the part in question as seen from the observation point specified by the user, and, in particular, including portions that are actually hidden in the displayed detailed image of the scene. The thumbnails are calculated by the server 2.

When calculating the thumbnail of a part, the server 2 has information, obtained from the client 3, about the size of the window and other observation conditions so that the thumbnail is in the same frame of reference and has the same resolution as the detailed image calculated by the server.

At the client 3, image processing is performed on the thumbnail so as to obtain a ghost-type rendering, by modifying the brightness and by adding a halo around the thumbnail. The client terminal 3 displays this miniature in transparency over the detailed image calculated by the server.

The “thumbnail highlight function is illustrated in FIG. 7. The image T of FIG. 7 corresponds to a detailed image calculated by the server, and the part for highlighting is the same as in FIG. 6. The thumbnail calculated by the server 2 is represented by the element V in FIG. 7. The image U in FIG. 7 shows the selected part highlighted in the detailed image by using the thumbnail V: it will be observed that portions of the part that were previously hidden can now be seen.

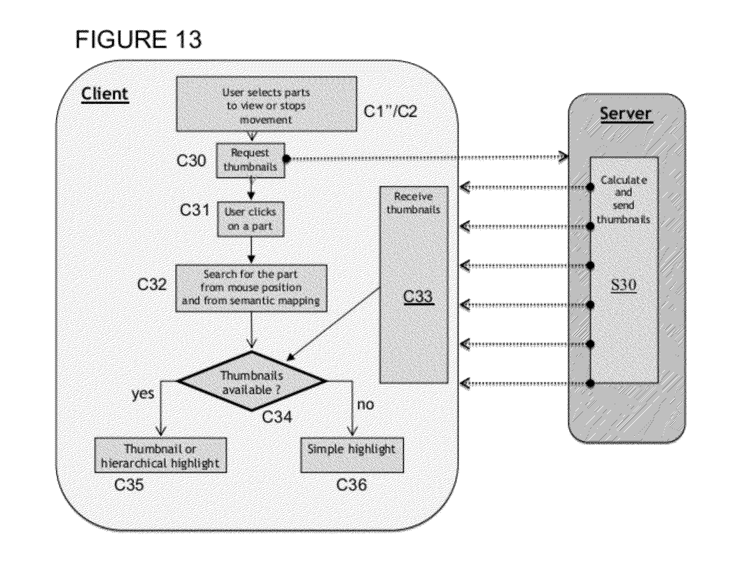

The calculation of the thumbnails may be triggered in various ways. In one situation, when the server 2 receives a request from the client 3 identifying the scene and/or the parts to be displayed together with observation conditions, either at the beginning of operation or else at the end of a change to observation conditions, the server proceeds to calculate not only the detailed image of the scene as viewed from the specific observation point, but also to calculate thumbnails for all of the parts that are visible in the detailed image. Some of the exchanges that may take place between the client 3 and the server 2 under such circumstances are indicated in FIG. 13. Depending on the circumstances, it may be advantageous for the detailed image to be sent to the client 3, possibly together with the semantic mapping, before sending the thumbnails (these first steps are not shown in FIG. 13).

In other cases, the thumbnails are calculated only when expressly requested, in particular on a request being made by the client terminal 3 at the moment when the user invokes the “thumbnail highlight” function in association with a selected part.

In contrast with the above-described “simple highlight” function, the “thumbnail highlight” function makes it possible to view hidden portions of a part. However, depending on the detailed implementation of the function (in particular how calculation of the thumbnail in question is triggered) this solution may involve the need to make a special request to the server 2 in order to obtain the thumbnail, which may thereby give rise to latency.

In certain embodiments of the invention, a hierarchical display function may be provided for the thumbnails that are used in association with assemblies of parts. In these embodiments, in the case of such an assembly of parts (a part constituted by a plurality of parts that may themselves be assemblies), the display of the parts may be ordered depending on the depth of the parts in the assembly tree: miniatures displayed in relation to components are more opaque than miniatures displayed in relation to the surrounding body. This constitutes using hierarchical transparency based on the assembly hierarchy.

For example, a screw may form part of a lock, which itself forms part of a door. By way of example, at the moment the thumbnails (which the client 3 has obtained from the server) are displayed, the client terminal 3 may display over the detailed image: the thumbnail corresponding to the screw with 0% transparency, the thumbnail corresponding to the lock with 30% transparency, and the thumbnail corresponding to the door with 60% transparency.

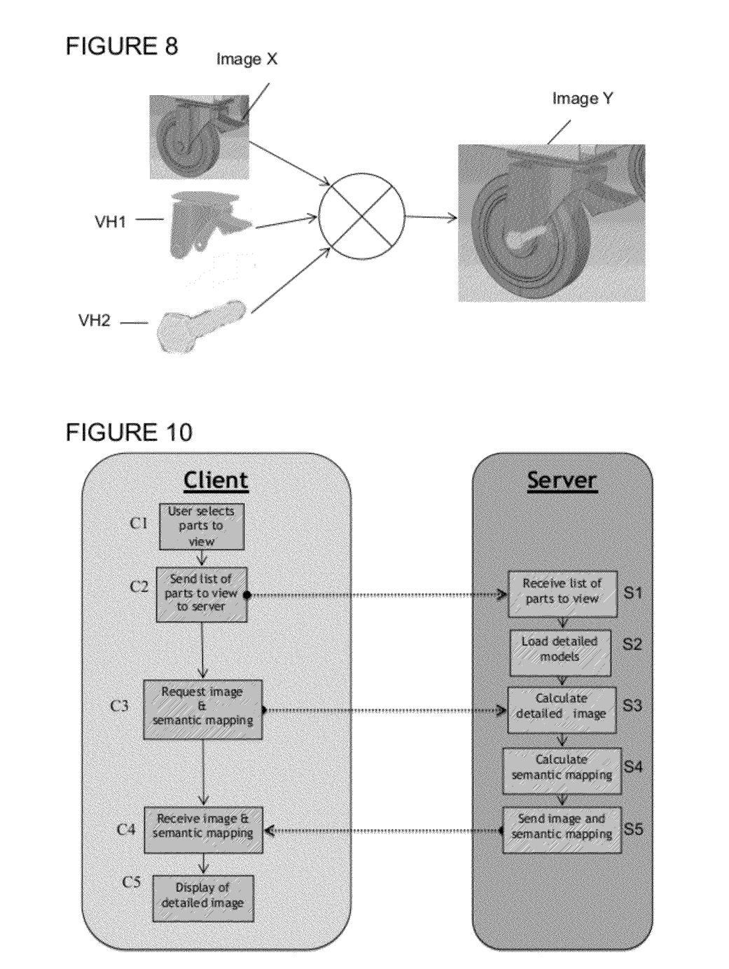

FIG. 8 illustrates this hierarchical display function. The image X in FIG. 8 corresponds to a region of the detailed image calculated by the server and the thumbnails calculated by the server 2 in relation to the two elements of an assembly for highlighting are shown by elements VH1 and VH2 in FIG. 8. The image Y in FIG. 8 shows the parts of the selected assembly highlighted in the detailed image by using the thumbnails VH1 and VH2 whose transparency has been adjusted, preferably at the client, end (so as to reduce the number of requests sent to the server 2, in order to reduce latency).

In contrast to a conventional approach in which the parts displayed in transparency are sorted relative to their depth in the 3D scene, the solution provided by these embodiments of the invention provides a better intuitive understanding of assemblies and of their hierarchy, such as for example which portions comprise line replaceable units (LRUs) and which portions constitute shop replaceable units (SRUs), even in the case where some of the parts are hidden.

The clients 3 and the server 2 dialog by means of requests—with the number and content thereof varying depending on the detailed implementation of the system—and by means of responses to the requests. Certain possible situations are illustrated in FIGS. 10 to 13.

### Exchanges Between Client and Server

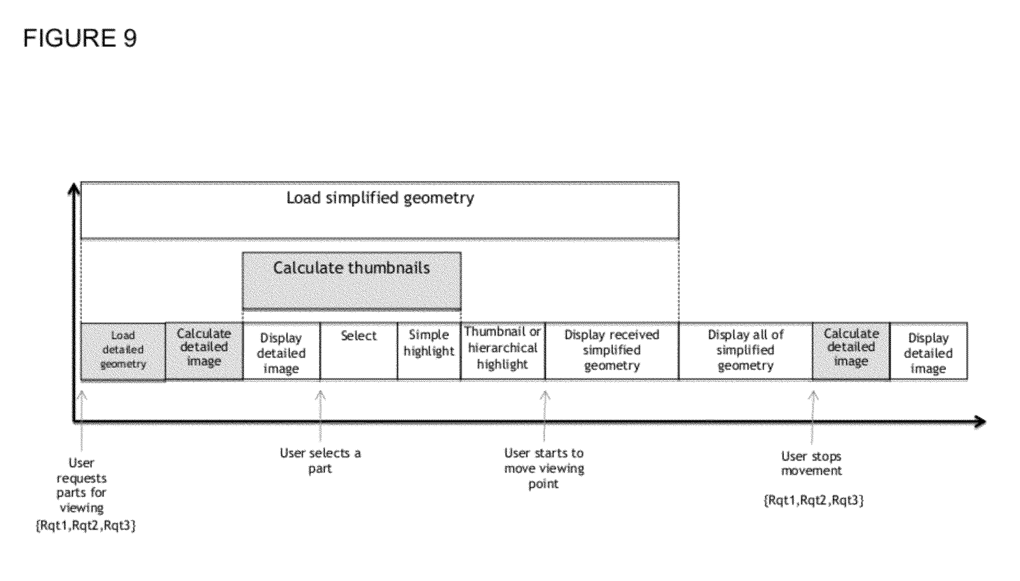

With reference to FIG. 9, there follows a description of an additional example of exchanges that may take place between a client 3 and the server 2 in a digital model consultation system 1 according to the first embodiment of the invention which makes use of semantic mappings and of thumbnails and which supports a hierarchical display of thumbnails in respect of assemblies of parts. In FIG. 9, gray rectangles represent processing performed at the client end while white rectangles represent processing performed at the server end.

In the example of FIG. 9, when a client 3 requests to view parts, the client sends three requests to the server
Rqt1=requests the server to provide data defining the simplified geometry of the intended scene;
Rqt2=requests the server to provide the precise image of the intended scene, as well as the semantic mapping; and
Rqt3=requests the server to provide the thumbnails.

As soon as the client 3 receives, from the server, the response to request Rqt1, the user can view the coarse geometry during movements. Once the client 3 has received the response from the server to request Rqt2, the user can view the static 3D scene in fine detail, can select parts in the scene, and can perform “simple highlighting”. As soon as the client 3 receives the response from the server to the request Rqt3, the user can perform “thumbnail highlighting”.

In this example, the various requests are sent, processed, and implemented in parallel. The requests have different response times. The response times to the requests can be ordered from the fastest to the slowest as follows: Rqt2, Rqt3, Rqt1. This means that the user may have a static image of the 3D scene at a fine level of detail almost immediately and can perform selection and “simple highlighting”. After waiting a little, the user can perform “thumbnail highlighting”. Finally, it the user waits long enough (several seconds), it becomes possible during movements to view images based on the full set of coarse 3D models. Naturally, the user is not obliged to wait for these few seconds to elapse before moving the observation point of the image; the user may begin to move sooner, but the image that is displayed during the movement will not he complete (it will be based on parts shown in degraded geometry whose coarsened data has already arrived).

In the example shown in FIG. 9, the data defining the scene according to a simplified geometry is transmitted to the client in parallel with the detailed image data, the semantic mapping, and the thumbnails. It is not necessary to synchronize the start of transmission of the data defining the simplified geometry with the start of transmission of the data concerning the detailed images. In the event, of coarsened data and detailed image data being transmitted sequentially, it is generally appropriate to transmit the detailed image data first (since the user has the guide image 42 making it possible to navigate in the model).

In order to limit waiting times, various other optimizations are possible:
compressing the image that is sent by the server, so as to reduce its size and thus to limit the time taken for it to be transferred over the network;
taking parts that have been received in degraded geometry from the server and putting them into cache memory at the client 3 so that they are available to be reused without making a fresh request to the server between two uses of the application;
calculating thumbnails only in relation to parts that are visible in the field of view of the current image; and
when calculating the thumbnails: calculating and sending to the client as a priority (i.e. first) the thumbnail of the part that the mouse is pointing at when Rgt2 is sent.

The above-described system 1 gives numerous users simultaneous access to the content of a three-dimensional digital model and also to its associated metadata via a network that need not have a particularly high transfer speed (and in particular via conventional Internet access) while eliminating the latency induced by the network, while remaining compatible with the limited power of client terminals, and while making use of degraded, partial, and preferably non-persistent 3D data at the client terminals. The user may use graphical selection to access the metadata associated with the elements making up the model.

The innovative architecture and task sharing of the system according to the invention make it possible to obtain simultaneously: conventional interactive functions, very high performance (in terms of response time, accuracy and resolution of the image, etc.) even when a large number of parts are to be displayed, while also protecting the intellectual property in the data, and to do so over a network that does not have any special protection, and even when calculation resources at the client end) and communications resources are limited.

### Implementation on an Independent Terminal

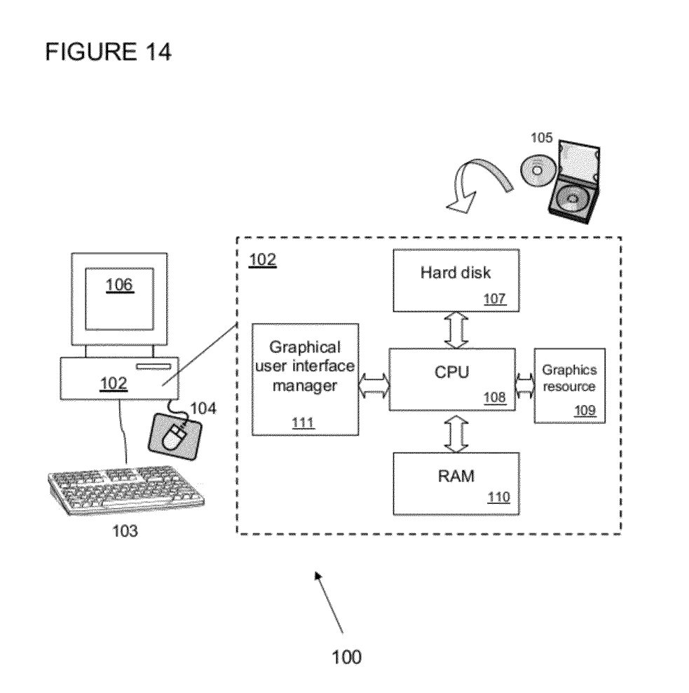

FIG. 14 is a diagram of an example of a system in which the user consults the digital model on an independent (autonomous) terminal, such as a personal computer (PC), or some other terminal.

It should be observed that in an independent terminal system the server functions of the preferred embodiment of the invention are performed by the independent terminal itself. To obtain this embodiment, the equipment at the independent, terminal takes charge both of the client functions and of the server functions of the preferred embodiment of the invention. The client and server computer program products are installed on the independent terminal and they communicate using the same application protocol as in the first embodiment, but without making use of any physical network function.

This solution is appropriate for users who do not have network access to the desired digital model. The voluminous data defining the digital model is supplied to the user on a suitable medium CDROM, DVD, or some other medium) and data confidentiality and compliance with intellectual property rights are ensured by one or more of the following measures—limiting data distribution to known users only, encrypting the data and/or using special formatting, degrading the geometry and/or adding noise to positions—which may be additional to license clauses, if any.

The autonomous user terminal may make use of a graphics interface identical to that of the above-described preferred embodiment and the functions made available to the user can be identical. Performance depends on the resources of the terminal. The terminal preferably comprises a workstation type PC possessing a significant amount of calculation power (e,g. a graphics card with 256 megabytes (MB) of memory for viewing a digital model made up of several thousand parts). The response time perceived by the user is improved when the data of the digital model is loaded onto the hard disk of the PC (i.e. the digital model is local on the hard disk).

### Mode of Operation—Autonomous Terminal

The various functions of consulting the digital model are performed as follows
when the user specifies the parts and/or the region of the model that is to be viewed, the detailed geometrical data relating to the parts in question is loaded by the central processor unit (CPU) from the hard disk of the PC;
the coarse geometrical data defining these parts in a simplified representation is calculated from the data of the digital model on the hard disk and/or extracted therefrom, with any required calculation being implemented by using the resources (CPU, memory, etc.) of the user terminal;
a detailed image is calculated from the detailed data of the model relating to the viewed parts, and possibly also to their environment (as viewed from the viewpoint specified by the user and, optionally, in compliance with other viewing conditions that the user has specified), this calculation being performed by using the resources of the user terminal;
the semantic mapping relating to the detailed image is calculated using the resources of the user terminal;
the thumbnails are calculated for parts having at least a portion visible in the detailed image, by using the resources of the PC;
the detailed image is displayed in accordance with the rules of the graphics interface used by the application/user terminal;
when the user moves the observation point in the 3D scene, or manipulates other observation conditions of the displayed scene, the image is recalculated using the coarsened data (unlike the first embodiment, the coarsened data is not only used by, but is also calculated in, the user terminal);
when the user selects a part, e.g. by positioning a cursor relative to the displayed image, the PC identifies the intended part by interrogating the semantic mapping in order to determine which part corresponds to the position of the cursor in the image;
the “simple highlight” function is performed by employing the semantic mapping (a technique that is much faster than an approach based on a ray-tracing method.); and
the “thumbnail highlight” function is performed by employing the thumbnails once they have been calculated locally.

### Modifications and Adaptations

Although particular embodiments of the present invention have been described above, the person skilled in the art will understand that various modifications and improvements can be made thereto within the spirit and scope of the present invention.

For example, in the above description of the first embodiment of the invention, the coarsened data that represents the simplified version of the digital model constitutes an element of that model, and when satisfying a request from one of its clients, the server proceeds to read the coarsened data that represents the parts selected by the client. Nevertheless, it, is possible to devise systems of the invention in which the coarsened data is calculated on the fly by the server on the basis of the detailed data, in particular for the purpose of satisfying a request from a client.

Furthermore, it is possible to supply the user client or user terminal with data that is simplified to a greater or lesser extent (relative to the more detailed data) as a function of the resources available at the client or user terminal and/or as a function of the properties of any transmission network (in particular the transfer speed or the congestion thereof). In the case of a high performance user terminal or client it is possible to create the coarsened data by deliberately making the detailed data noisy.

That is claimed is:

1. A system for consulting a digital model, the system comprising a server and at least one user terminal connected together by a communications link,
the server comprising means for accessing data defining a three-dimensional digital model; and
the user terminal comprising a display unit and a user interface enabling the user to define the observation conditions to be employed while displaying the digital model, and to define a scene corresponding to a subset of the parts making up the digital model,
wherein the server is adapted to transmit to the user terminal, via the communications link:
detailed image data corresponding to a scene defined by the user terminal, as calculated by the server in compliance with the observation conditions defined by the user terminal, the detailed image data being calculated by the server on the basis of data defining the parts of the digital model using a detailed geometry; and
coarsened data defining said scene defined by the user, according to a simplified geometry; and
wherein the user terminal further comprises:
receiver means adapted to receive said detailed image data and said coarsened data, the display unit being adapted to display a detailed image of said scene on the basis of the detailed image data received from the server; and
calculation means adapted to calculate image data representing said scene during a change of observation conditions, based on the coarsened data received from the server.

2. A digital model consultation system according to claim 1, wherein the server includes semantic mapping calculation means adapted to calculate a semantic mapping that indicates, for each location in the detailed image, an identifier of the corresponding part of the digital model, the server being adapted to send said semantic mapping to the user terminal, and the calculation means of the user terminal is adapted, when the user indicates a location in a detailed image displayed by the display unit, to identify the part selected by the user by consulting the semantic mapping in order to determine which part of the model corresponds to the location selected by the user.

3. A digital model consultation system according to claim 2, wherein the calculation means of the user terminal is adapted to control the rendering of the pixels of the image displayed by the display unit so that the pixels of the image that correspond to the part selected by the user, as identified from the semantic mapping, are rendered using displaying that highlights the part in question.

4. A digital model consultation system according to claim 2, wherein the server is adapted to send to the user terminal image data defining thumbnail images corresponding to the parts visible in the detailed image, and the calculation means of the user terminal is adapted, when the user selects a part displayed by the display unit, to verify whether the user terminal has a thumbnail of the part in question and to cause the received thumbnail to be displayed in superposition on the displayed image.

5. A digital model consultation system according to claim 4, wherein the calculation means of the user terminal is adapted, when the user selects an assembly displayed by the display unit, to verify whether the user terminal has thumbnails of the parts of the assembly in question and to cause the thumbnails of the parts of said assembly to be displayed with a hierarchical rendering in which the transparency of a displayed thumbnail depends on the level of the corresponding part in an assembly hierarchy.

6. A digital model consultation system according to claim 1, wherein the server is adapted to calculate said coarsened data corresponding to a simplified version of the digital model.

7. A digital model consultation system according to claim 4, wherein the server comprises thumbnail calculation means adapted to calculate the image data defining said thumbnails.

8. A user terminal for consultation of a three-dimensional digital model, the user terminal comprising a display unit and a user interface enabling the user to define the observation conditions to be used when displaying the digital model and to define a scene corresponding to a subset of the parts making up the digital model, wherein the user terminal further comprises:
receiver means adapted to receive from a server by means of a communications link:
image data defining a detailed image of the scene specified via the user interface, the image data being calculated under the observation conditions defined by the user interface; and
coarsened data defining said scene according to a simplified geometry;
the display unit being adapted to display a detailed image of said scene on the basis of the detailed image data received from the server; and
calculation means adapted to calculate image data representing said scene during a change of observation conditions, on the basis of said coarsened data received from the server.

9. A digital-model-consultation user terminal according to claim 8, wherein the receiver means is adapted to receive from the server a semantic mapping that specifies, for each location in the detailed image, an identifier of the corresponding part of the digital model, and the calculation means is adapted, when the user indicates a location in a detailed image displayed by the display unit, to identify the part selected by the user by consulting the semantic mapping received from the server.

10. A digital-model-consultation user terminal according to claim 9, wherein the calculation means is adapted to control the rendering of pixels of the image displayed by the display unit so that the pixels in the image that correspond to the part selected by the user, as identified from the semantic mapping, are rendered using displaying that highlights the part in question,

11. A digital-model-consultation user terminal according to claim 9, wherein the receiver means is adapted to receive from the server thumbnails of parts that are visible in the detailed image, and the calculation means is adapted, when the user selects a part displayed by the display unit, to verify whether the user terminal has a thumbnail for the part in question and to cause the thumbnail received from the server to be displayed in superposition on the displayed image.

12. A digital-model-consultation user terminal according to claim 11, wherein the calculation means is adapted, when the user designates an assembly displayed by the display unit, to verify whether the user terminal has thumbnails for the parts of the assembly in question and to cause the thumbnails of the parts of said assembly to be displayed with hierarchical rendering in which the transparency of a displayed thumbnail depends on the level of the corresponding part in the assembly hierarchy.

13. A digital-model-consultation system server adapted to enable a three-dimensional digital model to be consulted by at least one client, the server including means for accessing data defining the three-dimensional digital model according to a detailed geometry, and a client interface adapted to receive requests from the client and to provide data to the client in response;
wherein the server further comprises means for calculating image data defining a detailed image of a scene defined by a client and viewed under observation conditions defined by the client, said scene corresponding to a subset of the parts of the digital model selected by the client, the detailed image being calculated from said data defining the digital model according to the detailed geometry,
and wherein the client interface of the server is adapted to send to the client the detailed image data, and coarsened data defining said scene defined by the client, according to a simplified geometry.

14. A digital-model-consultation system server according to claim 13, further comprising semantic mapping calculation means configured to calculate a semantic mapping specifying for each location in the detailed image an identifier of the corresponding part in the digital model, and wherein the client interface is adapted to transmit said semantic mapping to the client.

15. A digital-model-consultation system server according to claim 14, further comprising thumbnail calculation means adapted to calculate image data defining thumbnails corresponding to parts visible in the detailed image provided to the client, and wherein the client interface is adapted to send said thumbnail-defining image data to the client.

16. A computer program product for implementing consultation of a three-dimensional digital model via a communications link, the product comprising instructions for performing the following steps on being executed:
inputting an instruction coming from a user indicating the observation conditions to be employed while displaying the three-dimensional digital model, and defining a scene corresponding to a subset of the set of parts of the digital model;
receiving from a server and via the communications link:
detailed image data defining a detailed image of the scene defined by the user and displayed under observation conditions defined by the user, the image data being calculated from data defining the three-dimensional digital model according to a detailed geometry; and
coarsened data defining said scene using a simplified geometry;
calculating image data representing said scene during a change of observation conditions, on the basis of coarsened data received from the server; and
displaying the image data produced during the calculation step.

17. A computer program product for enabling a three-dimensional digital model to be consulted by a client terminal, the product comprising instructions for performing the following steps on being executed:
receiving a request from a client; and
supplying data to the client in order to response to the request;
wherein the product further includes instructions for performing the following steps, on being executed;
accessing data defining the three-dimensional digital model according to a detailed geometry;
using said data defining the digital model using detailed geometry to calculate image data defining a detailed image of a scene defined by a client and viewed under observation conditions defined by the client, said scene corresponding to a subset of the parts of the digital model selected by the client; and
transmitting to the client:
said detailed image data; and
coarsened data defining said scene using si
